(19) United States
(12) Patent Application Publication
(10) Pub. No.: US 2003/0224333 A1
(43) Pub. Date: Dec. 4, 2003

(54) Suspended Motion system simulation theater

(76) Inventor: Jan Vastvedt, Houston, TX (US)

Correspondence Address: SLATER & MATSIL, L.L.P., 17950 PRESTON RD, SUITE 1000, DALLAS, TX, 75252-5793, US

(21) Appl. No.: 10/159,904

(22) Filed: May 31, 2002

(51) Int. Cl. G09B 9/02; G09B 19/16

(52) U.S. Cl. 434/29

(57) ABSTRACT

A simulator, comprising a cabin including a control mechanism and a plurality of windows. A screen is disposed proximate the cabin windows, and the screen includes a viewing area disposed beneath the cabin. At least one window may be disposed on the bottom of the cabin. A plurality of projectors is used to project images on the screen. The cabin is suspended downwardly from a motion actuator that is adapted to move the cabin in response to adjustments made to the control mechanism. The simulator may be used for operator training on container gantry cranes, straddle carriers, portal or harbor cranes, or tower cranes, as examples.

### TECHNICAL FIELD

This invention relates generally to simulators, and more particularly to simulators for training on crane machinery and equipment used to move large and/or heavy objects.

### BACKGROUND

Cranes are machines that are used to move large or heavy objects from one location to another. For example, in the marine industry, supplies from ships are carried in containers and large tanks (e.g., for the transportation of water and oil). When the ships arrive at a port, these containers and tanks must be moved from the ship to the dock, a train, or another ship, and later may be moved from a dock to other transportation vehicles such as trucks, trains, or other ships, as examples. A harbor crane is typically used to move these supplies from ships. Cranes are also used in construction to move steel beams and concrete members, and in the petroleum industry to move and position pipes, for example.

Operators of crane equipment must be extensively trained, because mistakes made while operating a crane can be dangerous and costly, costing lives and damaging the items being moved, objects in the surroundings, or the crane equipment itself. Training on actual cranes is costly, taking away from revenue-generating time on cranes and causing wear and tear on the crane. Therefore, simulators are often used to train crane operators.

One type of prior art crane simulators includes a software system implemented on a laptop or personal computer, for example. A joystick is used to maneuver the simulated crane, and images on the screen respond accordingly. However, this type of software does not provide the crane operator with a very wide field of vision for viewing the object being moved, the surroundings, or the various parts of the crane equipment.

Another type of simulator comprises a cabin similar to the cabin of actual crane equipment, with screens placed in front of the cabin. An operator enters the cabin and sits in a chair with a view of an environment similar to an actual crane cabin being projected on the screen. As the operator moves the controls, the images on the screen simulate what the crane operator would see while operating an actual crane. In some prior art crane simulators, the cabin is mounted on top of a motion base, and the cabin is moved by the motion base according to the operator's control choices, coordinated with the images on the screen. While this type of crane simulator gives the crane operator a more realistic feel of operating a crane, however, because the motion base is placed beneath the cabin, the field of vision below the cabin is limited. A full-sized screen cannot be placed beneath the cabin because the motion base resides there.

### SUMMARY

Embodiments of the present invention achieve technical advantages as a crane simulator having a cabin suspended from a frame or the ceiling of a room. A motion actuator is disposed between the cabin and the frame or ceiling. The field of vision of the operator is increased so that the operator is able to view a scene below the cabin, through a window in the cabin floor or through a steep front window, as examples.

In one embodiment, a simulator includes a cabin adapted to accommodate at least one person, the cabin comprising a control mechanism and a plurality of windows, a screen disposed proximate the cabin windows, and a motion actuator coupled to the cabin, wherein the cabin is suspended downwardly from the motion actuator, and wherein the motion actuator is adapted to move the cabin in response to adjustments made to the control mechanism.

In another embodiment, a virtual reality simulator for training a crane operator includes a cabin having a front, back, sides, bottom and top. The cabin includes a plurality of windows on at least the cabin front and sides, with the cabin being similar to an actual crane cabin. A chair is disposed within the cabin, wherein the crane operator may be seated in the chair. A steering mechanism is disposed proximate the chair, the steering mechanism being adapted to control the movement of the crane cabin. A control mechanism is disposed proximate the chair, wherein the control mechanism is adapted to control the operation of the crane. A screen is viewable by the operator through the cabin windows, and a plurality of projectors are disposed proximate the screen adapted to project images onto the screen. A motion actuator is coupled to the cabin top, wherein the cabin is suspended downwardly from the motion actuator, and wherein the motion actuator is adapted to move the crane and cabin in response to adjustments made to the control mechanism and steering mechanism. Images projected onto the screen correspond to the adjustments made and movement of the cabin.

In another embodiment, a method of manufacturing a virtual reality crane simulator includes providing a cabin having a plurality of windows, the cabin being similar to an actual crane cabin. The cabin is suspended from a motion actuator, and a screen is disposed proximate the windows, wherein the screen includes a viewing area that is underneath the cabin. The method includes providing a plurality of projectors adapted to project images onto the screen, attaching a chair to the cabin floor, and installing a control mechanism proximate the chair. A control system is coupled to at least the motion actuator, projectors, and control mechanism, wherein the control system is adapted to coordinate the cabin movement and projector images in response to adjustments made to the control mechanism.

Advantages of embodiments of the present invention include providing a crane simulator having a full simulated view out beneath the cabin, on the screen. Because the cabin is suspended from the motion actuator, the view beneath the cabin is not impeded, giving a more realistic and complete view of the objects, crane and scenery beneath the crane cabin and thus, providing improved training for crane operators.

### BRIEF DESCRIPTION OF THE DRAWINGS

The above features of embodiments of the present invention will be more clearly understood from consideration of the following descriptions in connection with accompanying drawings in which:

FIG. 1 illustrates a cabin simulator theater in accordance with an embodiment of the present invention, having a cabin suspended from a motion actuator and screens disposed over the cabin windows;

FIG. 2 shows a view of the inside of the cabin shown in FIG. 1, with cabin window screens visible to the operator on the cabin front, sides and floor, and a control panel positioned on either side of a steering wheel;

FIG. 3 illustrates a more detailed view of the left and right control panels shown in FIG. 2;

FIG. 4 shows a detailed perspective view of a motion actuator having motors disposed on a lower portion of a plurality of pistons;

FIG. 5 shows a cross-section of an embodiment of the motion actuator wherein the motors are disposed on an upper portion of the pistons, proximate the frame;

FIG. 6 shows a perspective view of a cabin simulator theater in accordance with another embodiment of the present invention, wherein a spherical screen is disposed around the cabin;

FIG. 7 shows a perspective view of the back of the cabin simulation theater shown in FIG. 6;

FIG. 8 shows a back view of a cabin simulation theater having an opaque spherical screen in accordance with an embodiment of the present invention, wherein a plurality of projectors are used to directly project images onto the spherical screen;

FIG. 9 shows a perspective view of the spherical screen of FIG. 8; and

FIG. 10 illustrates a block diagram of the system according to embodiments of the present invention.

Corresponding numerals and symbols in the different figures refer to corresponding parts unless otherwise indicated. The figures are drawn to clearly illustrate the relevant aspects of the preferred embodiments and are not necessarily drawn to scale.

### DETAILED DESCRIPTION OF PREFERRED EMBODIMENTS

A description of preferred embodiments of the present invention will be discussed, followed by a discussion of some advantages of the invention.

FIG. 1 shows a perspective view of a cabin simulation theater 100, or a virtual reality crane simulator, in accordance with a first embodiment of the present invention, wherein a cabin 112 is suspended from a motion actuator 120. Preferably the cabin 112 comprises a layout that is substantially similar to, or exactly the same as, the cabin of the crane equipment that an operator is being trained to control. For example, the cabin 112 may comprise an actual cabin from crane equipment, and may include the same windows 114 disposed thereon. The windows 114 may include front, window, side, back and bottom windows, as shown. The cabin 112 preferably comprises a plurality of relatively large windows 114 disposed on the front, sides and bottom, so that the operator has a wide field of vision while operating the crane simulator 100.

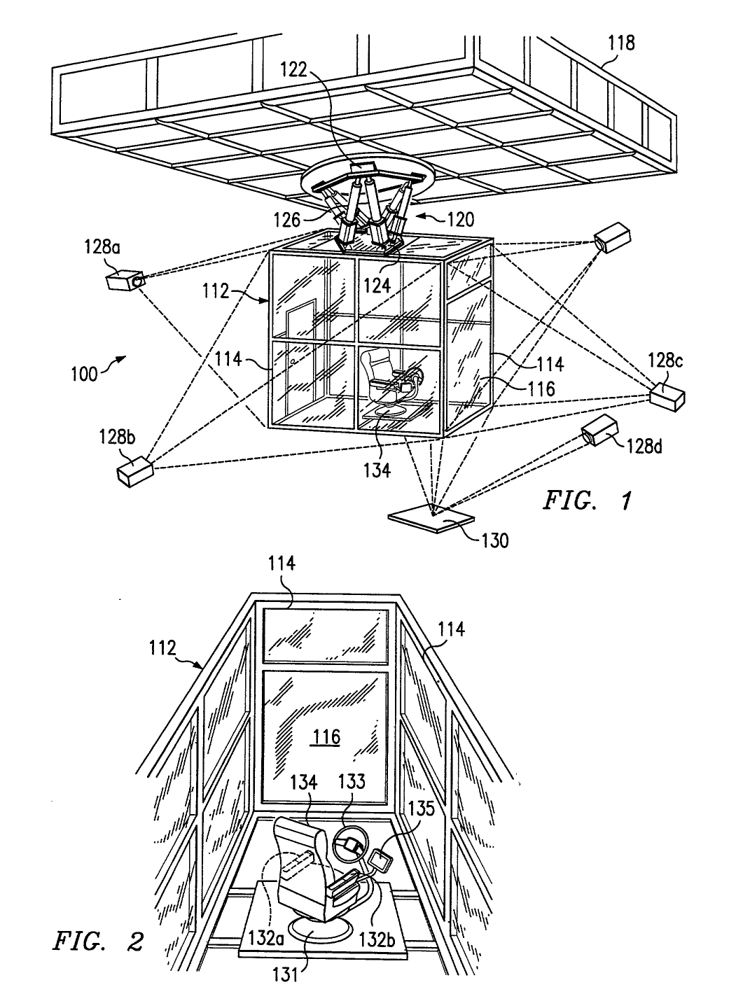

A chair 134 is fixedly attached to the cabin 112 floor adjacent a floor window 114. The chair 134 may be reclineable and may be adapted to pivot about a fixed axis, for example. The chair 134 may include two armrests, and alternatively, the chair 134 may not include armrests, for example. A control mechanism or panel 132, (not shown in FIG. 1; see FIG. 2) is attached to the cabin floor or chair 134, as examples, proximate the chair 134 and within the reach of the operator. The operator may enter the cabin 112 through a door disposed in the back of the cabin 112, using a stair or ladder (not shown).

In accordance with the embodiment of the invention, the motion actuator 120 is fixedly coupled to a support frame 118 or ceiling. The support frame 118 may comprise a plurality of first beams attached e.g. welded or formed at a ninety degree angle to a plurality of second beams, for example. The support frame 118 preferably comprises steel, and alternatively may comprise other materials such as aluminum, stainless steel, carbon fiber, or plastic, as examples. Preferably, the frame 118 comprises a material that is light, for ease of transport, yet strong enough to support the weight of the actuator 120, the cabin 112, the operator, and any necessary electronics.

The motion actuator 120 may comprise an upper attachment member 122 in a top region adapted to mechanically couple the motion actuator 120 to the frame 118 or ceiling. The motion actuator 120 also may comprise a lower attachment member 124 in a bottom region adapted to mechanically couple the motion actuator 120 to the cabin 112. The motion actuator 120 includes a plurality of pistons 126 coupled between the upper and lower attachment members 122/124. The pistons 126 may be expanded or retracted in response to signals from a control system 460 (see FIG. 10) in order to raise or lower the cabin 112 at different angles, according to the operator's use of the control mechanism 132 (see FIG. 2).

In the embodiment shown in FIG. 1, the windows 114 are covered with a plurality of screens 116. The screens 116 are preferably translucent so that an image may be projected onto the screens 116 from the outside of the cabin 112, wherein the projected image may be viewed by the operator inside the cabin 112, for example. The screens 116 may comprise a flexible material such as canvas, and alternatively may comprise plastic or glass, as examples. The screens 116 preferably include a viewing area that is underneath the cabin, e.g., on a window on the bottom floor of the cabin, or through a steep front window of the cabin.

A plurality of projectors 128 is preferably disposed about the exterior of the cabin 112, with the projectors 128 being adapted to project an image upon the screens 116 of the cabin 112. For example, projector 128a is adapted to project an image on the back screen 116, so the operator may turn his head around and view the image projected on the back window 114. Similarly, projector 128b is adapted to project an image onto the cabin right side screen 116, and projector 128c is adapted to project an image onto the cabin front screen 116. Mirrors 130 may also be used to project the images; for example, an image may be projected by projector 128d onto a mirror 130 that transfers the image to the cabin bottom window, as shown. The images of the plurality of projectors 128 are coordinated in accordance with signals received by the control mechanism 132 by a control system 460, (not shown in FIG. 1, see FIG. 10).

One or more speakers 466 (not shown in FIG. 1; see FIG. 10) may be disposed behind the screens 116 and/or within the cabin 112, as examples, although the speakers 466 may alternatively be placed in other locations. Sounds mimicking the sounds of an actual crane during operation may be produced over the speakers 466, providing a realistic training environment, coordinated by the control system 460.

A perspective view of the inside of the cabin 112 in accordance with the embodiment of FIG. 1 is shown in FIG. 2. An operator seated in the chair 134 is within easy reach of an optional steering mechanism or steering wheel 133 that is disposed in front of the chair 134. A control mechanism 132 is also disposed proximate the chair 134. The control mechanism 132 may comprise one or more controls, for example, including one of more of the following: rudders, handles, joysticks, or a combination thereof, disposed proximate the chair 134 within reach of the operator.

In the embodiment shown in FIG. 2, the control mechanism 132 comprises a left and right control panel 132a/132b disposed on the chair 134 armrests. The control mechanism 132 may alternatively comprise a single control panel, or two or more control panels placed proximate the chair 134. If the actual crane the operator is being trained to operate includes a touch screen, an embodiment of the invention may include an optional touch screen 135. For example, a touch screen 135 may be attached to one of the chair 134 armrests, for example, attached to the right armrest, as shown. Alternatively, the optional touch screen 135 may be disposed in other locations proximate the chair 134. Preferably, the control mechanism 132, steering mechanism 133, and touch screen 135 are placed in the same location as in the actual crane the operator is being trained to operate.

The chair 134 may include one or more handles or controls (not shown) adapted to adjust the chair 134 for a plurality of parameters, such as height, seat and back angle, seat distance from back, for example, to provide the operator the opportunity to employ an ergonomically sound seating position. In one embodiment, the steering wheel 133 is part of a console (not shown) that includes a gas and brake pedal, such as in a simulator for a straddle carrier. The console may be mounted on the base 131 of the chair 134 to enable the operator to drive the crane.

The chair 134 is preferably mounted on a base 131, such that the chair 134 may rotate on the base 131. The steering wheel 133 and pedal console may be mounted on another rotating base disposed underneath the chair base 131 to provide for independent rotation of the steering wheel console and the chair 134. The chair 134 may be rotated and locked in the following angles: −90 degrees, −45 degrees, 0 degrees, 45 degrees, and 90 degrees, as examples. The steering wheel 133 console is adapted to follow the chair 134 as it rotates. The steering wheel 133 is preferably attached to the chair 134 and is allowed to rotate up to 90 degrees to the side, to allow for a better front view when running the crane simulator 100.

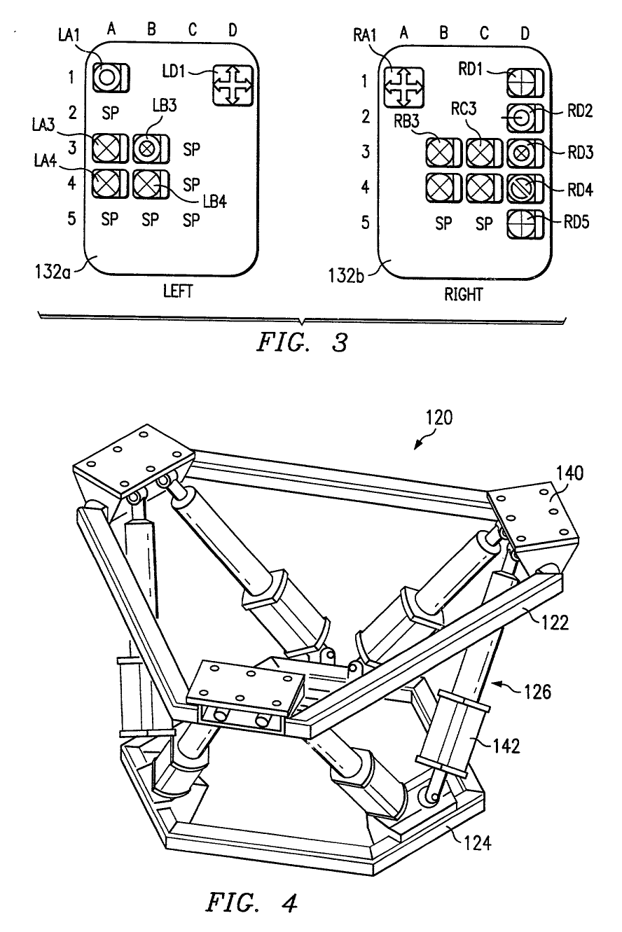

The control panels 132a/132b may comprise one or more of the following: joy-sticks, hydraulic or electric buttons, levers, alarm and indicator lights, as examples, to be described further herein with reference to FIG. 3.

The images projected on the screens 116 provide the perception to the operator that he is viewing a three-dimensional scene through the cabin windows 114. Thus, the cabin simulation theater 100 comprises a virtual reality theater. On the screens 116, the operator can view the boom or crane that seemingly extends from the equipment the cabin is associated with. The operator can view a hook or spreader (a claw-like object that is used to pick up objects) that is attached to the end of the boom. The operator can view objects such as containers and tanks that the operator is picking up and moving with the crane. The operator also has a view of the surroundings that the crane is simulating operation within.

The cabin 112 may be adapted to be moved to the left and right, and up and down by the suspended motion actuator 120, according to how the operator manipulates the control panel 132. The range of movement depends on the type of crane equipment the operator is being trained to operate. The images projected on the screens 116 are adapted to change in response to the operator's commands, made by moving the steering mechanism 133, control panels 132a/132b and optional touch screen 135. If the operator makes a mistake or bumps into something with the virtual reality crane shown in the images, the cabin 112 is moved by the motion actuator 120 so that the operator feels a realistic jolt or bump, for example.

FIG. 3 shows a left and right control panel 132a/132b in accordance with a preferred embodiment of the present invention. Preferably, the control panels 132a/132b are universal in design so that the cabin simulation theater 100 may be used for training on a variety of different styles and types of equipment. The cabin simulation theater 100 may be used for training on a high or low model container gantry crane, a straddle carrier, a portal or harbor crane, or a tower crane as examples.

### EXAMPLE 1

Table 1 illustrates exemplary functions of the left control panel 132a when the cabin simulation theater 100 is used to train an operator in the operation of a container gantry crane.

TABLE 1

| Device | Hardware | Description |
|---|---|---|
| LD1 (Joystick) | 2 axis, 5 button joystick | |
| N | | Trolley Fwd |
| S | | Trolley Bwd |
| E | | Crane Right |
| W | | Crane Left |
| LD1 Left Button | | |
| Push and hold | | |
| N | | List water side |
| S | | List land side |
| E | | Trim right |
| W | | Trim left |
| NE | | Skew right |
| NW | | Skew left |
| SE | | Skew right |
| SW | | Skew left |
| LD1 Right Button | | Selected flippers |
| Double-click | | up/down |
| LA1 | Buzzer | Buzzer |
| LA3 | Push button momentary w/ | Alarm (lamp/ack) |
| | lamp, red | |
| LB3 | Push button momentary, black | Horn Silence |
| LA4 | Lamp, white | Spreader landed |
| LB4 | Lamp, white | Twin lift mode (detect) |

Table 2 illustrates exemplary functions of the right control panel 132b when the cabin simulation theater 100 is used as a container gantry crane.

TABLE 2

| Device | Hardware | Description |
|---|---|---|
| RA1 (Joystick) | 2 axis, 5 button joystick | |
| N | | Lower |
| S | | Hoist |
| E | | |
| W | | |
| RA1 Left Button | | Twist locks |
| Double-click | | lock/unlock |
| RA1 Right Button | | Spare |
| RD1 | Push button emergency stop | Gantry Crane |
| | | Emergency Stop |
| RD2 | Key switch, 2 position | Start control system |
| RB3 | Lamp, blue | Twist locks locked |
| RC3 | Lamp, white | Twist locks unlocked |
| RD3 | Push button latching w/lamp, | Power on/off |
| | green | |
| RD4 | Push button latching w/lamp, | Rail brake on/off |
| | red | |
| RD5 | Push button emergency stop | Simulator Emergency |
| | | Stop |

Tables 3-6 illustrate exemplary functions of the optional touch screen 135 when the cabin simulation theater 100 is used to train an operator in the operation of a container gantry crane, in various modes. A spreader screen (Table 3), boom screen (Table 4), crane screen (Table 5), and lights screen (Table 6) are depicted, although other screens may be available, such as alarm and messages screens, as example, for the various operations of the crane equipment.

TABLE 3

| Functionality | Functionality |
|---|---|
| Hydraulic pump on/off | Reset trim/list/skew position |
| 20 ft select | Select left/right land-/waterside |
| | flippers |
| 40 ft select | Bypass 2 × 20 detection |
| 45 ft select | Heavy load mode on/off |
| 2 × 20 ft select | |
| Over-height connect/disconnect | Head frame locked indication |
| Long twin adjustment in/out | Spreader cable connected indication |
| Store long twin adjustment | Twist locks locked/unlocked indica- |
| | tion |
| Zero long twin setting | Spreader landed indication |
| Go to long twin memory position | Twin lift mode detection indication |

TABLE 4

| | |
|---|---|
| Functionality | Functionality |

Boom hoisting system on/off
Boom lift/lower
Boom stop
Enable override of boom/ship detection system
Override boom/ship collision detection interlock

TABLE 5

| Functionality | Functionality |
|---|---|
| Bypass crane/crane anti collision system | Another station on indication |
| Bypass sill beam anti collision system | Emergency stop on indication |
| Bypass wind speed | Trolley park position indication |
| Set trolley accelerations (normal, wet | Overload indication |
| rail . . . ) | |
| Anti-sway on/off | Crane stowed indication |
| | Wind speed too high indication |
| | Wind speed indication |
| | Load indication |
| | Hoist position |
| | Trolley position |

TABLE 6

| | |
|---|---|
| Functionality | Functionality |

Lamp test
Floodlight trolley on/off
Floodlight portal on/off
Floodlight boom on/off

### EXAMPLE 2

Table 7 illustrates exemplary functions of the left control panel 132a when the cabin simulation theater 100 is used to train an operator in the operation of a straddle carrier crane.

TABLE 7

| Device | Hardware | Description |
|---|---|---|
| LD1 (Joystick) | 2 axis, 5 button joystick | |
| N | | Shift left |
| S | | Shift right |
| E | | Shift fwd |
| W | | Shift bwd |
| NE | | Skew fwd ccw |
| NW | | Skew bwd cw |
| SE | | Skew fwd cw |
| SW | | Skew bwd ccw |
| LD1 Left Button | | Spare |
| LD1 Right Button | | Spreader zero position |
| Double-click | | |
| LA1 | Buzzer | Buzzer |
| LA3 | Push button momentary w/ | 24 V indication |
| | lamp, red | |
| LB3 | Push button momentary, black | Reset PLC |
| LA4 | Lamp, white | Spare |
| LB4 | Lamp, white | Spare |

Table 8 illustrates the functions of the right control panel 132b when the cabin simulation theater 100 is used to train an operator in the operation of a straddle carrier crane.

TABLE 8

| Device | Hardware | Description |
|---|---|---|
| RA1 (Joystick) | 2 axis, 5 button joystick | |
| N | | Lower |
| S | | Hoist |
| E | | Drive direction fwd |
| W | | Drive direction bwd |
| RA1 Left Button | | Twist locks |
| Double-click | | lock/unlock |
| RA1 Right button | | 20 ft/40 ft |
| Double-click | | |
| RD1 | Push button emergency stop | Straddle Carrier |
| | | Emergency Stop |
| RD2 | Key switch, 2 position | Start control system |
| RB3 | Lamp, blue | Twist locks locked |
| RC3 | Lamp, white | Twist locks unlocked |
| RD3 | Push button latching w/lamp, | Diesel/power on/off |
| | green | |
| RD4 | Push button latching w/lamp, | Park brake on/off |
| | red | |
| RD5 | Push button emergency stop | Simulator Emergency |
| | | Stop |

The functions of the touch screen 135 when the cabin simulation theater 100 is used as a straddle carrier crane maybe similar to those shown in Tables 3-6, above, for example.

### EXAMPLE 3

Table 9 illustrates the functions of the left control panel 132a when the cabin simulation theater 100 is used to train an operator in the operation of a portal or harbor crane.

TABLE 9

| Device | Hardware | Description |
|---|---|---|
| LD1 (Joystick) | 2 axis, 5 button joystick | |
| N | | Boom lower |
| S | | Boom hoist |
| E | | Rotate cw/Drive right |
| W | | Rotate ccw/Drive left |
| LD1 Left Button | | Engage portal drive/ |
| Double-click | | |
| LD1 Right Button | | Spare |
| LA1 | Buzzer | Buzzer |
| LA3 | Push button momentary w/ | Alarm (lamp/ack) |
| | lamp, red | |
| LB3 | Push button momentary, black | Horn silence |
| LA4 | Lamp, white | Portal drive engaged |
| LB4 | Lamp, white | Spare |

Table 10 illustrates the functions of the right control panel 132b when the cabin simulation theater 100 is used to train an operator in the operation of a portal or harbor crane.

TABLE 10

| Device | Hardware | Description |
|---|---|---|
| RA1 (Joystick) | 2 axis, 5 button joystick | |
| N | | Lower |
| S | | Hoist |
| E | | |
| W | | |
| RA1 Left Button | | |
| RA1 Right button | | |
| RD1 | Push button emergency stop | Portal Crane |
| | | Emergency Stop |
| RD2 | Key switch, 2 position | Start control system |
| RB3 | Lamp, blue | Spare |
| RC3 | Lamp, white | Spare |
| RD3 | Push button latching w/lamp, | Diesel/power on/off |
| | green | |
| RD4 | Push button latching w/lamp, | Park brake on/off |
| | red | |
| RD5 | Push button emergency stop | Simulator Emergency |
| | | Stop |

The functions of the touch screen 135 when the cabin simulation theater 100 is used as a portal or harbor crane may be similar to those shown in Tables 3-6, above, for example.

Other indicators, buttons, levers, and switches may be included on the control panels 132a/132b. Spare positions for additional features are indicated by “SP” in FIG. 3.

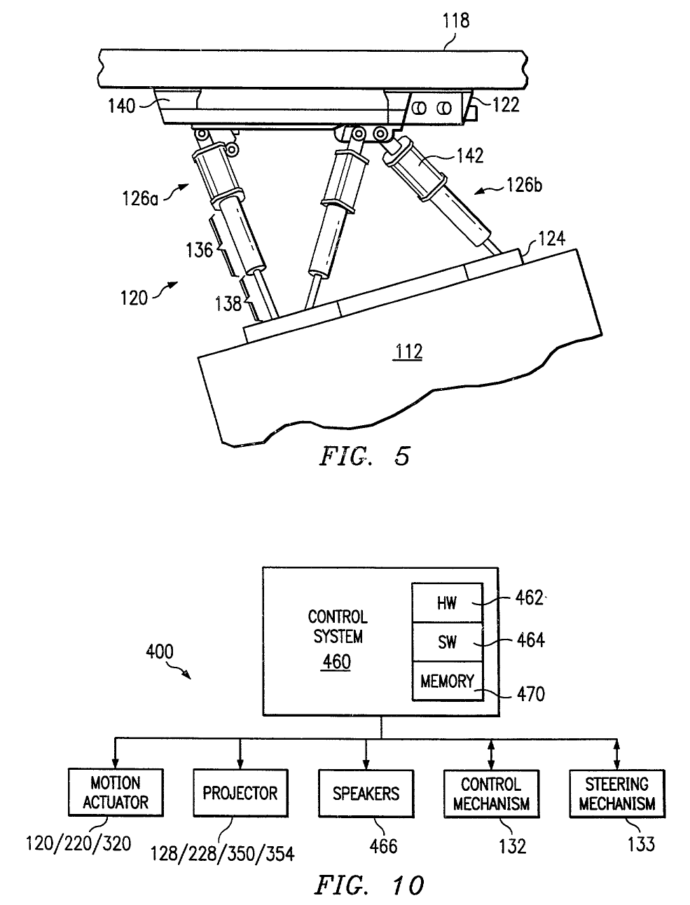

FIG. 4 shows a perspective view of a motion actuator 120 in accordance with embodiments of the invention. The motion actuator 120 includes an upper attachment member 122, a lower attachment member 124, and a plurality of pistons 126 disposed therebetween. The upper attachment member 122 is preferably substantially triangular in shape, although alternatively, the upper attachment member 122 may comprise other shapes, such as circular or square, as examples. The upper attachment member 122 preferably comprises at least two brackets 140, and more particularly, preferably comprises three brackets 140 for coupling the motion actuator 120 to the frame 118 (see FIG. 1). The brackets 140 may be coupled to the frame 118 using a plurality of screws and nuts, for example. Alternatively, other fastening mechanisms may be used to couple the motion actuator 120 to the frame 118 or directly to a ceiling, for example.

The motion actuator 120 preferably comprises a set of two pistons 126 coupled at a first end to each corner of a triangular-shaped upper attachment member 122, as shown. The lower attachment member 124 is also preferably triangular in shape (although other shapes may be used), and one of the piston set 126 is coupled to one corner of the lower attachment member 124, while the other of the piston set 126 is coupled to an adjacent corner of the lower attachment member 124, as shown. Preferably, exactly six pistons 126 are coupled between the upper and lower attachment members 122/124, although fewer or more pistons 126 may be used, for example.

The pistons 126 are preferably coupled to the upper and lower attachment members 122/124 by a bolt and nut, for example, although alternatively, other mechanical attachment devices may be used. Each piston 126 includes a motor 142 that is adapted to retract or extend the piston 126 to provide movement of the cabin 112. In the motion actuator embodiment 120 shown in FIG. 4, the motors 142 are disposed on the lower portion of the pistons 126, proximate the cabin 112 (not shown). This is advantageous because the lubricant used for the interface of the piston portion 136/138 will naturally flow downhill (e.g., towards the cabin 112) along the length of the pistons 126, below the motors 142. The upper and lower attachment members 122/124 preferably comprise steel, although alternatively, the upper and lower attachment members 122/124 may comprise other materials such as composite plastics or other metals, as examples. The pistons 126 preferably comprise stainless steel, and may alternatively comprise other corrosion-resistant materials such as titanium or other materials, as examples.

FIG. 5 shows a cross-sectional view of an embodiment of the motion actuator 120 wherein the motors 142 are disposed on the upper portion of the pistons 126, proximate the frame 118. The motors 142 are relatively heavy, and positioning the motors 142 above the pistons 126 decreases the amount of total weight that must be supported by the pistons 126 and motion actuator 120. The pistons 126 comprise a fixed length portion 136 and a telescoping variable length portion 138 concentrically and moveably disposed within the fixed length portion 136, as shown in FIG. 5. The motor 142 is adapted to retract or extend the telescoping variable length portion 138 according to commands received from the control system 460 (to be described further herein with reference to FIG. 10).

Referring again to FIG. 5, piston 126a is shown with telescoping portion 138 being partially extended, while piston 126b is fully retracted. By varying the piston 126 positioning in this manner, the motion actuator 120 is adapted to move portions of or the entire cabin 112 up and down relative to the frame 118, which remains fixedly attached to the ceiling.

In one embodiment, the motion actuator 120 comprises exactly six pistons 126. Alternatively, to save costs, the motion actuator 120 may comprise less than six pistons 126; for example, the motion actuator 120 may comprise exactly three pistons 126. The motion actuator 120 may include an element adapted to turn the cabin, not shown. The turning element may comprise at least one roller and a motor to turn the roller, for example. The motion actuator 120 may also include one or more hydraulic power units (HPU's) adapted to move the pistons 126.

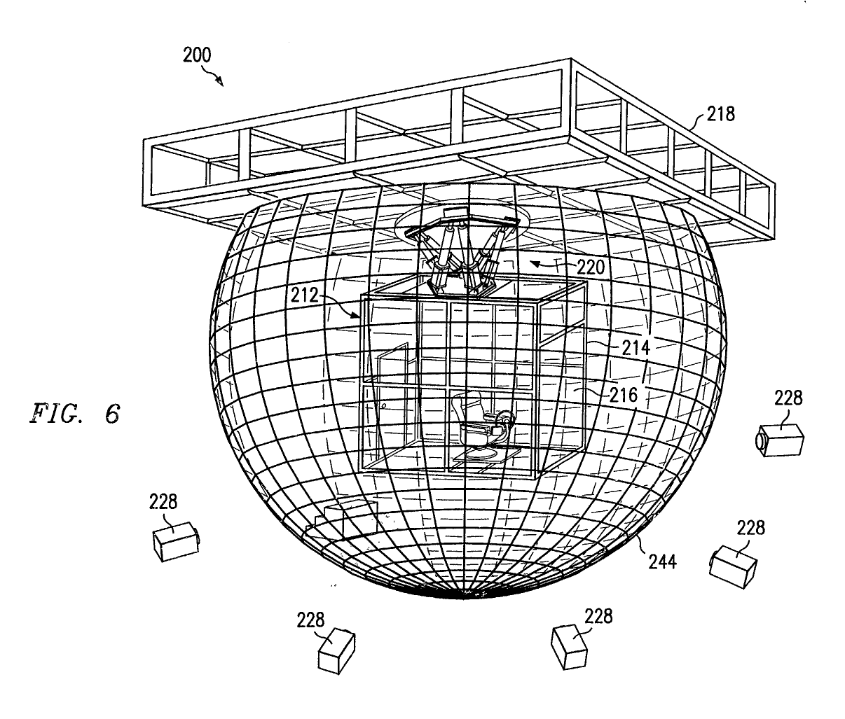

FIG. 6 shows a perspective view of a cabin simulator theater 200 in accordance with another embodiment of the present invention, wherein a spherical screen 244 is disposed around a cabin 212. Rather than having screens 116 disposed over windows 114 as described for the embodiment shown in FIG. 1, the windows 214 are either transparent or have the glass removed, so that the spherical screen 244 is completely within view of the operator. A portion of the operator viewing area is underneath or beneath the cabin 212, for example, through a bottom window 214 or through a steep front window 214. Because the back of the spherical screen 244 is open to allow the operator to enter the cabin 212, the back window may include a screen 216 disposed thereon, with an image being projected thereon from the outside of the cabin 212, for example.

The cabin 212 is suspended from a frame 218 or ceiling by a motion actuator 220. The spherical screen 244 preferably comprises a translucent material such as canvas, glass or plastic, supported by a frame comprising aluminum or steel, as examples. The spherical screen 244 and frame may alternatively comprise other materials. A plurality of projectors 228 is adapted to project the simulator images onto the spherical screen 244 from the exterior of the cabin 212, as shown. One or more speakers (not shown in FIG. 6; see FIG. 10) may be disposed behind the spherical screen 244 and/or within the cabin 212, as examples, although speakers may alternatively be placed in other locations.

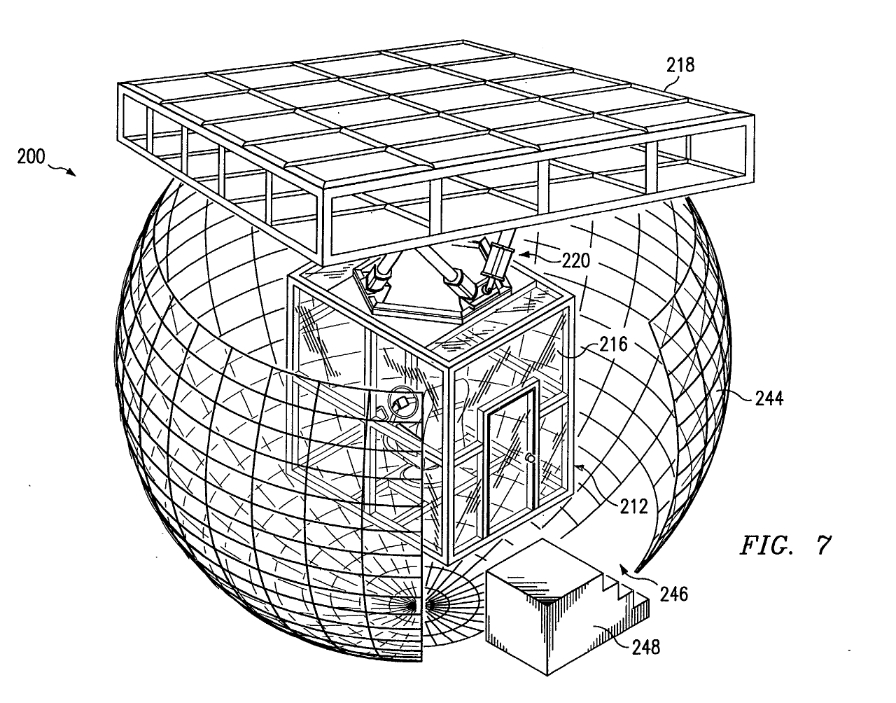

A perspective view of the back of the cabin simulation theater 200 of FIG. 6 is shown in FIG. 7. The spherical screen 244 may include a cut-out 246 in the back thereof, to allow entry of the operator into the cabin 212. Optional stairs 248 may be disposed near the cabin 212 so that an operator may enter the suspended cabin 212. Alternatively, the cabin 212 may be lowered (e.g. by fully extending the motion actuator 220 pistons) prior to the operator entering the cabin 212. The frame 218 is also optional; alternatively, the motion actuator 220 may be fixedly attached directly to the ceiling of a room, for example. The cabin simulation theater 200 may be installed in a single room so that the lights may be darkened, for example, and so the operator will not be interrupted by external noises during use of the theater 200.

FIG. 8 shows a back view of a cabin simulation theater 300 having a substantially opaque spherical screen 344 in accordance with an embodiment of the present invention, wherein a plurality of projectors 354 are disposed above the cabin 312. The projectors are adapted to directly project images onto the spherical screen 344, from the interior of the spherical screen 344 or the interior of the cabin 312, or both, for example. The projectors 354 may be coupled directly to the upper attachment member 322, as shown, or may alternatively be coupled to the frame 318. Projectors 350 may be also disposed beneath the cabin 312, adapted to project images onto the spherical screen 344 from the interior of the spherical screen 344. The cut-out 346 in the back provides entry to the cabin simulation theater 300 by an operator.

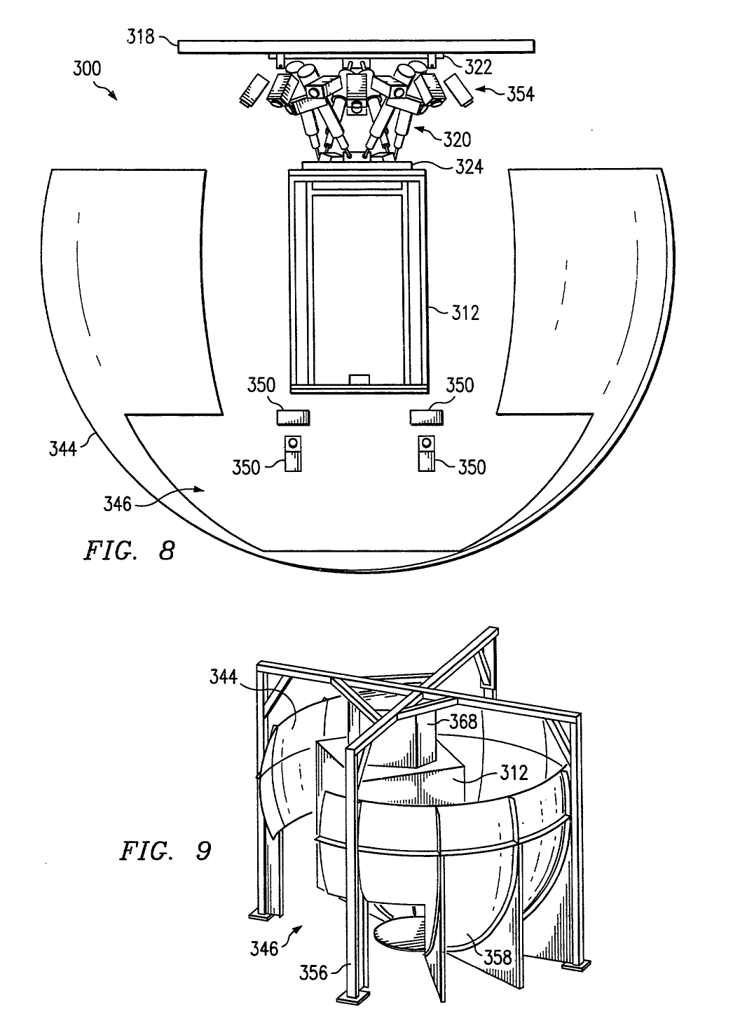

FIG. 9 shows a perspective view of the spherical screen 344 in accordance with an embodiment of the present invention. In this embodiment, the dome screen 344 comprises a plurality of opaque, spherical-shaped screen sections 358, comprising canvas, for example, although alternatively, other materials may be used. The spherical-shaped screen sections 358 are coupled together and are supported by a plurality of screen supports 356, as shown. The screen supports 356 preferably comprise fiberglass, and may alternatively comprise aluminum, steel, wood, or other materials, as examples. The screen sections 358 preferably comprise polyester and may alternatively comprise polyester reinforced with fiberglass, or other types of cloth or other materials, as examples. For example, the screen sections 358 may comprise polyester stretched over fiberglass screen supports 356, wherein the polyester screen sections 358 have fiberglass attached, e.g., welded or coated, to the polyester in some portions, to provide additional support to the dome screen 344 structure. The spherical screen 344 includes a cut-out 346 in back. The cabin 312 is suspended by a motion actuator (not shown) coupled to the screen supports 356. A plurality of optional mirrors 368 may be used to deflect images from projectors (not shown) onto the interior of the opaque spherical screen 344.

FIG. 10 illustrates a block diagram of a functional system 400 in accordance with embodiments of the present invention. A control system 460 may be coupled to a motion actuator 120/220/320, a plurality of projectors 128/228/350/354, optional speakers 466, control mechanism 132, and steering mechanism 133, as shown. The control system 460 may comprise hardware 462 and software 464 adapted to control and coordinate the functions of the cabin motion simulator 400. The control system 460 may also include memory 470 adapted to store one or more training programs, e.g., for various types of crane equipment. The functions of the cabin motion simulator 400 that are controlled and coordinated by the control system 460 include, but are not limited to: the mechanical movement of the motion actuator 120/220/320, the projectors 128/228/350/354 that project visual images onto either the front of back of screens 116, 216, 244/344, optional speakers 466 that may disposed anywhere in the room the cabin simulation theater is located in. The control system 460 is adapted to coordinate the operation of these elements in response to commands from the operator that are received by the control mechanism 132 and steering mechanism 133 that the operator is behind the controls of. Preferably, the images produced by the projectors 128/228/350/354 are digital, although, alternatively, analog images may be utilized in the cabin simulation theater 100/200/300/400. The control system memory 470 may be adapted to store software programs and data, and may be adapted to store programs for the simulator 400 for one or more types of crane or other equipment.

An embodiment of the invention includes a method of manufacturing a virtual reality crane simulator. The method includes providing a cabin having a plurality of windows, the cabin being similar to an actual crane cabin, and suspending the cabin from a motion actuator. A screen is disposed proximate the windows, wherein the screen includes a viewing area that is underneath the cabin. The method includes providing a plurality of projectors adapted to project images onto the screen, attaching a chair to the cabin floor, installing a control mechanism proximate the chair, and coupling a control system to at least the motion actuator, projectors, and control mechanism, wherein the control system is adapted to coordinate the cabin movement and projector images in response to adjustments made to the control mechanism.

The simulators described herein may be used to train operators on a variety of hydraulic and mechanical crane equipment, as examples. While embodiments of the cabin simulation theater in accordance with the present invention are described herein with reference to crane simulators, they also have useful application in other simulators, such as for cranes used in the construction and petroleum industry, as examples. Other types of simulators would benefit from a cabin suspended by a motion actuator, as well.

Embodiments of the present invention provide an advanced crane simulator 100/200/300/400 with improved training effectiveness. When seated in the chair 134/234, an operator has the sensation of operating an actual crane. While sitting in the cabin 112/212/312, the operator may operate the control mechanism 132 and steering mechanism 133, and feel movements, hear sounds, and view the surroundings as he would during the operation of a real crane. Thus, embodiments of the cabin simulation theater 100/200/300/400 provide a virtual reality crane simulator.

Embodiments of the present invention provide several advantages over prior art cabin simulation theaters. Unimpeded images on screens through the cabin 112/212/312 floor window or steep front window are visible to the operator because the cabin 112/212/312 is suspended from motion actuator 120/220/320. The field of vision of the operator is increased with embodiments of the present invention, resulting in improved operation and safety training. In one embodiment, the piston motors 142 are disposed proximate the upper attachment member 122, to reduce the weight load on the motion actuator 120. Images may be projected either from the back side of the screens 116/244, or alternatively, images may be projected from the front side of the screen 344. Optional mirrors 130/368 may be used to deflect the projected images, or alternatively, the images may be projected directly onto screen 344. The amount of time required to train on actual cranes may be decreased, by the use of embodiments 100/200/300/400 of the present invention.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. In addition, the order of process steps may be rearranged by one of ordinary skill in the art, yet still be within the scope of the present invention. It is therefore intended that the appended claims encompass any such modifications or embodiments. Moreover, the scope of embodiments of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. A simulator, comprising:
a cabin adapted to accommodate at least one person, the cabin comprising a control mechanism and a plurality of windows;
a screen disposed proximate the cabin windows; and
a motion actuator coupled to the cabin, wherein the cabin is suspended downwardly from the motion actuator, and wherein the motion actuator is adapted to move the cabin in response to adjustments made to the control mechanism.

2. The simulator according to claim 1, wherein the screen includes a viewing area disposed beneath the cabin.

3. The simulator according to claim 1, further comprising at least one projector adapted to project video images onto the screen.

4. The simulator according to claim 3, further comprising at least one mirror disposed between at least one projector and the screen, wherein the mirror deflects the image from the projector onto the screen.

5. The simulator according to claim 3, wherein a plurality of translucent screens are disposed over the cabin windows.

6. The simulator according to claim 5, wherein the projectors are adapted to project images onto the screens from the exterior of the cabin.

7. The simulator according to claim 3, wherein the screen is substantially spherical-shaped, wherein the cabin is suspended within the spherical screen.

8. The simulator according to claim 7, wherein the screen is translucent, wherein the projectors are adapted to project images onto the spherical screen from the exterior of the spherical screen.

9. The simulator according to claim 7, wherein the screen is opaque, wherein the projectors are adapted to project images onto the spherical screen from the interior of the cabin or from the interior of the spherical screen, or both.

10. The simulator according to claim 1, further comprising a support frame, wherein the motion actuator is suspended from the support frame.

11. The simulator according to claim 1, wherein the control mechanism comprises a left control panel, a right control panel, and a touch screen.

12. The simulator according to claim 3, further comprising a control system coupled to and adapted to coordinate the movements of the motion actuator and projected images according to adjustments made to the control mechanism.

13. A virtual reality simulator for training a crane operator, comprising:
a cabin having a front, back, sides, bottom and top, the cabin comprising a plurality of windows on at least the cabin front and sides, the cabin being similar to an actual crane cabin;
a chair disposed within the cabin, wherein the crane operator may be seated in the chair;
a steering mechanism disposed proximate the chair, the steering mechanism being adapted to control the movement of the crane cabin;
a control mechanism disposed proximate the chair, the control mechanism being adapted to control the operation of the crane;
a screen viewable by the operator through the cabin windows;
a plurality of projectors disposed proximate the screen adapted to project images onto the screen; and
a motion actuator coupled to the cabin top, wherein the cabin is suspended downwardly from the motion actuator, wherein the motion actuator is adapted to move the crane and cabin in response to adjustments made to the control mechanism and steering mechanism, and wherein images projected onto the screen correspond to the adjustments made and movement of the cabin.

14. The simulator according to claim 13, further comprising at least one mirror disposed between at least one projector and the screen, wherein the mirror is adapted to deflect images from the projector onto the screen.

15. The simulator according to claim 13, wherein a plurality of translucent screens are disposed over the cabin windows, wherein the projectors are adapted to project images onto the screens from the exterior of the cabin.

16. The simulator according to claim 13, wherein the screen is substantially spherical-shaped, wherein the cabin is suspended from the motion actuator within the spherical screen.

17. The simulator according to claim 16, wherein the screen is translucent, wherein the projectors are adapted to project images onto the screen from the exterior of the spherical screen.

18. The simulator according to claim 16, wherein the screen is opaque, wherein the projectors are adapted to project images onto the screen from the interior of the cabin or from the interior of the spherical, or both.

19. The simulator according to claim 13, further comprising a support frame, wherein the motion actuator is suspended from the support frame.

20. The simulator according to claim 13, wherein the control mechanism comprises at least one control device.

21. The simulator according to claim 13, wherein the chair includes a left armrest and a right armrest, wherein the control mechanism comprises a left control panel coupled to the left armrest, and wherein the control mechanism comprises a right control panel coupled to the right armrest.

22. The simulator according to claim 21, further comprising a touch screen coupled to an armrest of the chair, wherein the touch screen may be used to operate or interact with a spreader, a boom, a crane, lights, alarms and messages viewable on the screen or left or right control panels.

23. The simulator according to claim 13, further comprising at least one speaker disposed proximate the cabin, the speaker being adapted to produce sounds.

24. The simulator according to claim 13, further comprising a control system coupled to at least the steering mechanism, control mechanism, projectors, and motion actuator, wherein the control system is adapted to coordinate the images projected, control commands received from the control mechanism and steering mechanism, and movement of the cabin by the motion actuator.

25. The simulator according to claim 24, wherein the control system comprises hardware, software, and memory, wherein the memory is adapted to store one or more virtual reality programs.

26. The simulator according to claim 25, wherein the virtual reality programs comprise software for training on container gantry cranes, straddle carriers, portal or harbor cranes, or tower cranes.

27. The simulator according to claim 13, wherein the motion actuator comprises an upper attachment member, a lower attachment member, and a plurality of pistons disposed between the upper and lower attachment members, wherein the cabin is attached to the motion actuator at the lower attachment member, and wherein the pistons are retractable and extendable to move the cabin.

28. The simulator according to claim 27, wherein the motion actuator comprises exactly six pistons.

29. The simulator according to claim 27, wherein the motion actuator comprises at least three pistons and an element adapted to turn the cabin.

30. The simulator according to claim 27, wherein the motion actuator includes a hydraulic power unit adapted to move the pistons.

31. The simulator according to claim 13, wherein the screen includes a viewing area disposed beneath the cabin.

32. A method of manufacturing a virtual reality crane simulator, comprising:
providing a cabin having a plurality of windows, the cabin being similar to an actual crane cabin;
suspending the cabin from a motion actuator;
disposing a screen proximate the windows, wherein the screen includes a viewing area that is underneath the cabin;
providing a plurality of projectors adapted to project images onto the screen;
attaching a chair to the cabin floor;
installing a control mechanism proximate the chair; and
coupling a control system to at least the motion actuator, projectors, and control mechanism, wherein the control system is adapted to coordinate the cabin movement and projector images in response to adjustments made to the control mechanism.
